(19) United States
(12) Patent Application Publication
(10) Pub. No.: US 2026/0289603 A1
(43) Pub. Date: Sep. 24, 2026

(54) ADVERTISEMENT PLACEMENT POSSIBILITY DETERMINATION DEVICE, ADVERTISEMENT PLACEMENT POSSIBILITY DETERMINATION METHOD, AND NON-TRANSITORY RECORDING MEDIUM

(71) Applicant: NEC Corporation, Tokyo (JP)

(72) Inventors: Rui KONDO, Tokyo (JP); Yasuhiko Yoshida, Tokyo (JP); Shinnosuke Nishimoto, Tokyo (JP)

(73) Assignee: NEC Corporation, Tokyo (JP)

(21) Appl. No.: 19/557,541

(22) Filed: Mar. 5, 2026

(30) Foreign Application Priority Data
Mar. 18, 2025 (JP) 2025-043982

(51) Int. Cl. G06Q 30/0241

(52) U.S. Cl. CPC G06Q 30/0241

(57) ABSTRACT

An advertisement placement possibility determination device including an analysis unit for identifying and analyzing an object arranged in a metaverse space posted by a user, a soundness score calculation unit for calculating a soundness score of the object by Artificial Intelligence (AI), a total soundness score calculation unit for calculating a total soundness score of the metaverse space based on the soundness score, and a determination unit for determining whether to display an advertisement in a space based on the total soundness score is provided.

### INCORPORATION BY REFERENCE

This application is based upon and claims the benefit of priority from Japanese patent application No. 2025-043982, filed on Mar. 18, 2025, the disclosure of which is incorporated herein in its entirety by reference.

### TECHNICAL FIELD

The present disclosure relates to an advertisement placement possibility determination device, an advertisement placement possibility determination method, and a program.

### BACKGROUND ART

JP 2020-52546 A discloses an information processing device that determines whether main content is suitable to be placed on the web based on image data or text data.

### SUMMARY

However, the advertisement placement possibility determination device in a metaverse space has not been studied. Therefore, an example object of the present disclosure is to provide a device that determines whether to place an advertisement in a metaverse space based on soundness of an object.

An advertisement placement possibility determination device according to an example aspect of the present disclosure is an advertisement placement possibility determination device including
an analysis unit for identifying and analyzing an object arranged in a metaverse space posted by a user,
a soundness score calculation unit for calculating a soundness score of the object by Artificial Intelligence (AI),
a total soundness score calculation unit for calculating a total soundness score of the metaverse space based on the soundness score, and
a determination unit for determining whether to display an advertisement in a space based on the total soundness score.

An advertisement placement possibility determination method according to an example aspect of the present disclosure is an advertisement placement possibility determination method including
identifying and analyzing an object arranged in a metaverse space posted by a user,
calculating a soundness score of the object by AI,
calculating a total soundness score of the metaverse space based on the soundness score, and
determining whether to display an advertisement in a space based on the total soundness score.

A program according to an example aspect of the present disclosure is a program for causing an information processing device to execute
identifying and analyzing an object arranged in a metaverse space posted by a user,
calculating a soundness score of the object by AI,
calculating a total soundness score of the metaverse space based on the soundness score, and
determining whether to display an advertisement in a space based on the total soundness score.

According to an example advantage of the present disclosure, a device that determines whether to place an advertisement in the metaverse space based on the soundness of the object can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an outline of a metaverse space according to the present disclosure;

FIG. 2 is a diagram illustrating display of an advertisement in the metaverse space according to the present disclosure;

FIG. 3 is a block diagram illustrating a configuration of an advertisement placement possibility determination device according to the present disclosure;

FIG. 4 is a flowchart of an advertisement placement possibility determination method according to the present disclosure;

FIG. 5 is a block diagram illustrating a configuration of an information processing device according to the present disclosure; and

FIG. 6 is a block diagram illustrating a second configuration of an advertisement placement possibility determination device according to the present disclosure.

### EXAMPLE EMBODIMENTS

### Description of Metaverse Space According to Example Embodiment

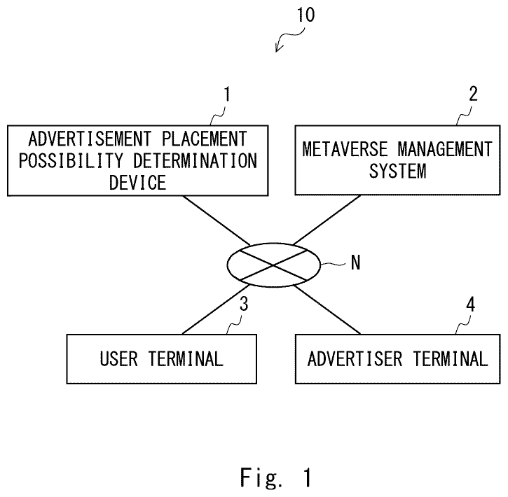

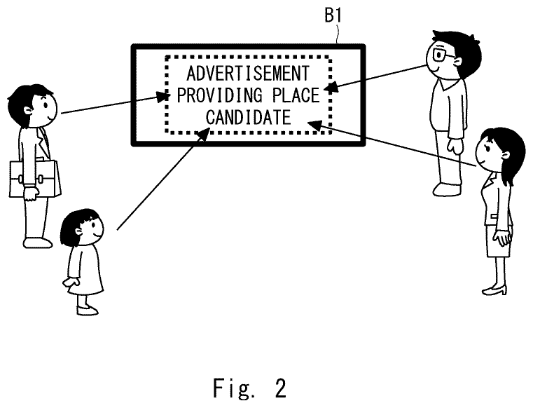

FIG. 1 is a diagram illustrating an outline of a metaverse space according to the present disclosure. FIG. 2 is a diagram illustrating a display of an advertisement in the metaverse space according to the present disclosure. A metaverse space according to an example embodiment will be described with reference to FIGS. 1 and 2.

The metaverse space is a three-dimensional virtual space constructed on the Internet. The metaverse space can create a place to chat with voice or text by posting a space in which an individual arranges objects according to preference. The metaverse space creates an atmosphere such as academic, realistic, cyberpunk, lovely, urban, natural, and the like, and accepts access from a person who likes the atmosphere.

As illustrated in FIG. 1, a metaverse 10 includes an advertisement placement possibility determination device 1, a metaverse management system 2, a user terminal 3, an advertiser terminal 4, and the like connected via a network N. The metaverse 10 may be connected to a metaverse poster terminal. The network N is the Internet such as a telephone line or an electric communication line.

The advertisement placement possibility determination device 1 is a device that determines whether an advertisement can be placed in a metaverse space created by an individual. Whether an advertisement can be placed here is at the discretion of the advertiser. The advertisement placement possibility determination device 1 calculates the soundness of the metaverse space by Artificial Intelligence (AI) or the like. The advertiser sets the soundness and permits advertising if the soundness is equal to or higher than a certain level.

The metaverse management system 2 provides a posting platform of the metaverse space to an individual poster. The individual poster can create a desired metaverse space through the metaverse poster terminal. The individual poster arranges objects in the metaverse space. The creation of the atmosphere of the metaverse space is basically left to the discretion of an individual.

The user terminal 3 is a terminal of an individual that can enter a specific metaverse space and perform a chat or the like. The user can operate his/her own avatar in the metaverse space by using a Personal Computer (PC), a portable terminal, a head mounted display, or the like. On the screen of the user terminal 3, the visual field of the avatar is displayed in a first-person view or a third-person view. For example, in a case where the user terminal 3 is a head mounted display, the user terminal 3 detects the movement of the head of the user and moves the visual field of the avatar. The head mounted display may also be able to track the gaze by tracking the movement of the user's iris.

As illustrated in FIG. 2, an advertisement may be reproduced in a case where a display object B1 imitating a display installed in the metaverse space is displayed on the display screen of the user terminal 3. The display portion of the advertisement may be determined by a direction at the time the character or the user wearing the head mounted display moves the face back and forth and left and right. In the metaverse space, the advertisement can be set to be distributed to the display object in a case where the display object B1 detects the gaze.

An advertiser terminal 4 is a terminal managed by an advertiser that inputs an advertisement. An advertiser cannot select a metaverse space in which to advertise. However, the advertiser does not want to advertise in such a metaverse space that lowers its own evaluation. Therefore, there is a demand for a device that automatically evaluates the soundness of the metaverse space and places an advertisement in the metaverse space that has been evaluated to a certain extent.

### Description of Advertisement Placement Possibility Determination Device According to Example Embodiment

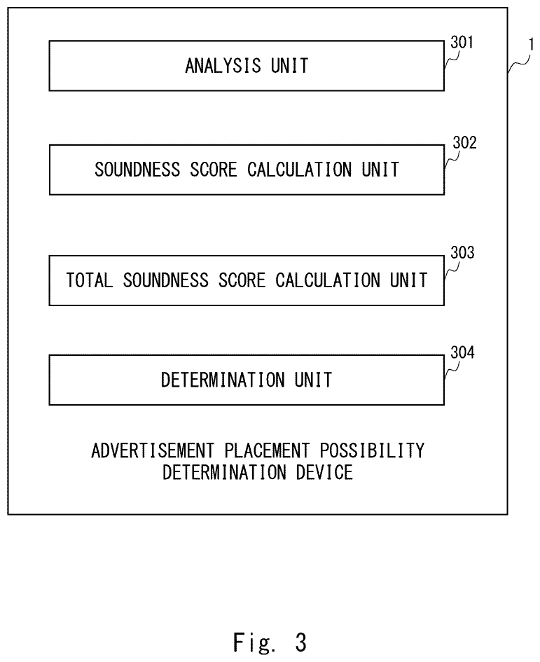

FIG. 3 is a block diagram illustrating a configuration of the advertisement placement possibility determination device according to the present disclosure. An advertisement placement possibility determination device according to an example embodiment will be described with reference to FIG. 3. The advertisement placement possibility determination device according to the example embodiment is a device that determines whether an advertiser may place an advertisement in a specific metaverse space.

As illustrated in FIG. 3, the advertisement placement possibility determination device 1 includes an analysis unit 301, a soundness score calculation unit 302, a total soundness score calculation unit 303, and a determination unit 304.

The analysis unit 301 identifies and analyzes an object arranged in the metaverse space. The object is a physical object. The object may be a balloon, an electric light, a stage, or anything. Therefore, there is a possibility that a physical object having an obscene shape or a physical object evoking an extreme idea is arranged. The analysis unit 301 identifies and analyzes all the objects arranged in the metaverse space.

The soundness score calculation unit 302 calculates the soundness score of the object by AI. The soundness score is a numerical value indicating soundness according to so-called public order and morality and public welfare. The soundness score is determined for each object. Therefore, it is possible to confirm which object deteriorates the soundness score. The soundness score calculation unit 302 may calculate the soundness score including not only the object but also the entire space. An atmosphere such as academic, realistic, cyberpunk, lovely, urban, and natural of the metaverse space may be determined by the soundness score without using the AI. A space having an obscene atmosphere or an atmosphere evoking an extreme idea may be determined as having a low soundness score.

The total soundness score calculation unit 303 calculates the total soundness score of the metaverse space based on the soundness score. The total soundness score may be the lowest value or an average of the soundness scores of the objects, or some adjustment may be made. As the total soundness score, a score may be calculated for each predetermined space of the metaverse. In the following description, the higher the soundness score, the closer the sound is, and the lower the soundness score, the closer the unsound is, but the correspondence relationship between the level of the soundness score and the soundness determination is not limited thereto. Adjustment of the soundness score will be described in the first example embodiment.

The determination unit 304 determines whether to display an advertisement in the space based on the total soundness score. For example, if the total soundness score is 6, an advertiser may advertise, but another advertiser may not wish to advertise. The advertiser can set the total soundness score to equal to or greater than 7 or equal to or greater than 5 as a criterion of whether to display the advertisement. In addition, the advertiser may set different placement criteria depending on the metaverse space. For example, the placement condition may be set to be high in a metaverse space having an atmosphere like a busy street where bars are lined, or the placement condition may be set to be low in a place where there are children. The determination unit 304 determines whether to display the advertisement according to the criteria of the total soundness score designated by the advertiser.

The total soundness score is preferably calculated periodically. After advertisement placement, the metaverse space may be modified, or the soundness score of the metaverse space may change based on the action history of the visiting user. It is preferable that whether to advertise is changed according to the change in the total soundness score, and the advertisement is automatically withdrawn. The total soundness score may be calculated in a case where the number of advertisement candidates increases, the advertisement candidates exceed a predetermined number, or at predetermined timing, such as at three months, six months, or one year. In a case where there are a plurality of advertisement candidates having the same condition, the determination unit 304 may preferentially select a candidate with a higher advertisement rate to be paid by placing an advertisement.

The analysis unit 301, the soundness score calculation unit 302, the total soundness score calculation unit 303, and the determination unit 304 may be reread as an analysis means, a soundness score calculation means, a total soundness score calculation means, and a determination means.

According to the above configuration, a device that determines whether to place an advertisement can be in the metaverse space based on the soundness of the object can be provided.

### Description of Advertisement Placement Possibility Determination Method According to Example Embodiment

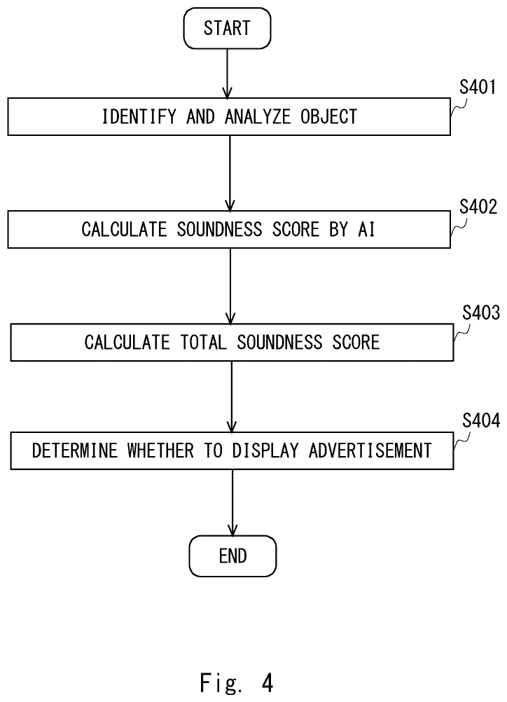

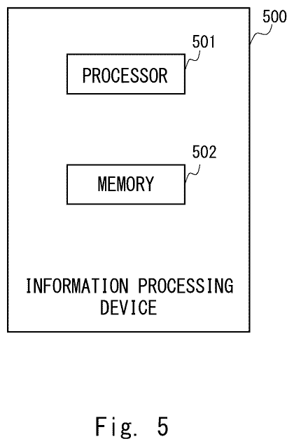

FIG. 4 is a flowchart of an advertisement placement possibility determination method according to the present disclosure. FIG. 5 is a block diagram illustrating a configuration of an information processing device according to the present disclosure. An advertisement placement possibility determination method according to the example embodiment will be described with reference to FIGS. 4 and 5.

As illustrated in FIG. 4, first, an object is identified and analyzed (step S401). The analysis unit 301 of the advertisement placement possibility determination device 300 identifies and analyzes the objects arranged in the metaverse space. Next, a soundness score is calculated by AI (step S402). The soundness score calculation unit 302 calculates the soundness score of the object by AI.

Next, a total soundness score is calculated (step S403). The total soundness score calculation unit 303 calculates the total soundness score of the metaverse space based on the soundness score. Finally, it is determined whether to display an advertisement (step S404). The determination unit 304 determines whether to display an advertisement in the space based on the total soundness score. For example, the determination unit 304 compares the soundness score with the advertisement placement condition such as “soundness score of equal to or greater than 7” set by the advertiser. In a case where the soundness score satisfies the placement condition, the determination unit 304 determines to display the advertisement. In a case where the soundness score does not satisfy the placement condition, the determination unit 304 determines not to display the advertisement. The placement condition may be changed according to an attribute or a time zone of the metaverse space. The attribute is, for example, a type and a color tone of an object installed in the metaverse space, a word described in a title and an explanation of the metaverse space, registration information such as gender and age of a user who uses the metaverse space, brightness of the entire metaverse space, and the like.

The user who can enter the metaverse space may be restricted based on the total soundness score. For example, if the total soundness score is low, a user of a predetermined age or younger may be prevented from entering the metaverse space.

According to the above, a method for determining whether to place an advertisement in a metaverse space based on the soundness of an object can be provided.

The above method is executed by executing a program in the information processing device and performing processing. As illustrated in FIG. 5, an information processing device 500 includes a processor 501 for physically executing a program to perform processing, and a memory 502 for storing the program. The information processing device 500 may include one device or a plurality of devices. The information processing device 500 may be a cloud server that processes some or all of the functions in a distributed manner. The information processing device 500 may be reread as the advertisement placement possibility determination device 1.

Some or all of the processing in the advertisement placement possibility determination device 1 and the information processing device 500 described above can be achieved as a computer program. Such a program can be stored and supplied to a computer by using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (for example, a magneto-optical disc), a Compact Disc Read Only Memory (CD-ROM), a CD-R, a CD-R/W, and a semiconductor memory (e.g., a mask ROM, a Programmable ROM (PROM), an Erasable PROM (EPROM), a flash ROM, or a Random Access Memory (RAM)). The program may be supplied to the computer by using various types of transitory computer-readable media. Examples of the transitory computer-readable medium include electric signals, optical signals, and electromagnetic waves. The transitory computer readable media can supply the programs to the computer via a wired communication line such as an electric wire and an optical fiber, or a wireless communication line.

### Description of Advertisement Placement Possibility Determination Device According to First Example Embodiment

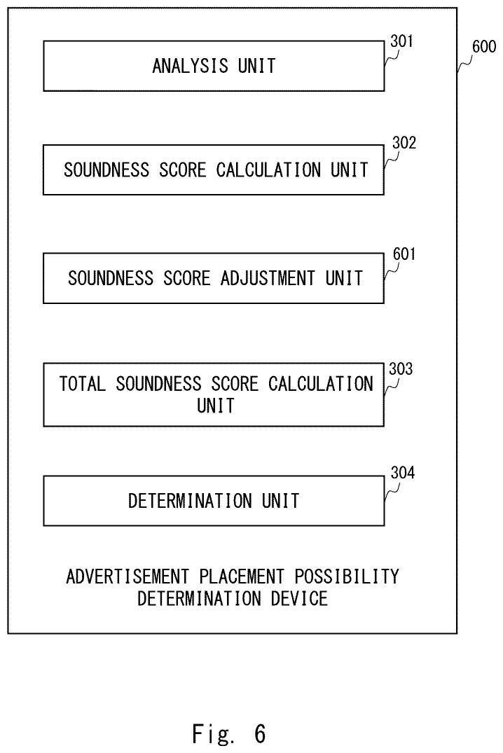

FIG. 6 is a block diagram illustrating a second configuration of the advertisement placement possibility determination device according to the present disclosure. The advertisement placement possibility determination device according to the first example embodiment will be described with reference to FIG. 6.

An advertisement placement possibility determination device 600 according to the first example embodiment is different from the advertisement placement possibility determination device 1 according to the example embodiment in that a soundness score adjustment unit 601 is further arranged.

The soundness score adjustment unit 601 adjusts the soundness score and reflects the adjusted soundness score in the total soundness score. For example, the soundness score adjustment unit 601 adjusts the soundness score based on a relationship among a plurality of objects arranged within a predetermined distance. An object itself of a person is not unsound, but may have another meaning if objects of a plurality of people are in close proximity. The soundness score adjustment unit 601 adjusts the soundness score by focusing on the relationship among such objects.

In addition, the soundness score adjustment unit 601 may adjust the soundness score using a language model specialized for text content in the metaverse space. A text displayed in the metaverse space may be determined and a soundness score may be adjusted by using a Large Language Model (LLM). For example, the soundness score adjustment unit 601 may determine whether obscene words are pasted on the object, whether a broadcast prohibited word is displayed, or the like.

Furthermore, the soundness score adjustment unit 601 may adjust the soundness score based on the user's vote. Mechanical evaluation may not accurately measure soundness. The soundness score adjustment unit uses the evaluation of the user who has visited the metaverse space for adjustment of the soundness score. For example, the soundness score adjustment unit 601 may take a questionnaire regarding the inside of the metaverse space to a plurality of users who have visited the metaverse space, and evaluate the metaverse space.

In addition, the soundness score adjustment unit 601 may analyze the audio content in the metaverse space and adjust the soundness score. The metaverse space includes audio content. The soundness score adjustment unit 601 may input the audio content to the LLM and output the soundness score. The soundness score adjustment unit 601 may include the audio content in the evaluation of the soundness score. The soundness score adjustment unit 601 may determine and evaluate whether obscene words are included, whether broadcast prohibited words are included, or whether seductive music is played in the audio distributed in the metaverse space.

Furthermore, the soundness score adjustment unit 601 may analyze the communication history in the metaverse space and adjust the soundness score. The soundness score adjustment unit 601 may keep a log of the communication history between the users in the metaverse space and reflect the log in the evaluation of the soundness score. Specifically, the soundness score adjustment unit 601 may adjust the soundness score by acquiring a chat history between the users. Furthermore, the soundness score adjustment unit 601 may adjust the soundness score based on a voice conversation between the users. In a case where the users communicate with each other a comment that lowers the soundness score, the soundness score is lowered. In addition, in a case where there is no comment that lowers the soundness score for a certain period such as one hour or several hours, the soundness score may be increased. The soundness score may be lowered as the number of comments that lower the soundness score increases. In addition, the soundness score may be lowered by the number of comments that lower the soundness score per unit time. The comment that lowers the soundness score is, for example, a comment against public order and morality and public welfare, an obscene comment, or a comment of extreme idea.

The soundness score adjustment unit may be reread as a soundness score adjustment means.

With the above configuration, the soundness score can be flexibly adjusted, and an advertisement can be placed in a soundness metaverse space according to the will of the advertiser.

The soundness score may be notified to the poster of the metaverse space. The poster can change the object according to the aiming soundness score. Furthermore, which object in the metaverse space lowers the total soundness score may be notified to the poster. In a case where the soundness score aimed by the poster is set, an object having a low soundness score in the metaverse space may be automatically replaced with an object having a high soundness score at the time the soundness score lowered.

A function of displaying a list of a plurality of top-ranked objects having deteriorated soundness scores may be included. In the case of this object, it may be determined that there is no problem in the user determination, and the advertisement placement may be proceeded. If such cases overlap and can be used for learning, it is possible to evaluate the soundness according to the advertisement attribute from the advertisement attribute and the space attribute. For example, in the case of an advertisement of an adult product, there is no problem even if there is an adult object in the advertisement target space, and thus the soundness evaluation is set high. Naturally, if there is an unsound object other than adult objects in the advertisement target space, for example, an object that induces fraud, the soundness may be evaluated to be low.

Furthermore, the soundness score may be calculated from the avatar of the user who frequently visits the evaluation target space. In a case where the avatar that frequently visits the evaluation target space is making an unsound statement or is visiting a space having a low soundness score, the soundness score may also be lowered by the evaluation target space.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may be described as the following Supplementary Notes, but are not limited to the following.

### (Supplementary Note 1)

An advertisement placement possibility determination device including
an analysis unit for identifying and analyzing an object arranged in a metaverse space posted by a user,
a soundness score calculation unit for calculating a soundness score of the object by Artificial Intelligence (AI),
a total soundness score calculation unit for calculating a total soundness score of the metaverse space based on the soundness score, and
a determination unit for determining whether to display an advertisement in a space based on the total soundness score.

### (supplementary Note 2)

The advertisement placement possibility determination device according to supplementary note 1, further including a soundness score adjustment unit for adjusting the soundness score,
in which the soundness score adjustment unit adjusts the soundness score based on a relationship among a plurality of the objects arranged within a predetermined distance. (Supplementary Note 3)

The advertisement placement possibility determination device according to supplementary note 1, further including a soundness score adjustment unit for adjusting the soundness score,
in which the soundness score adjustment unit adjusts the soundness score using a language model specialized for text content in the metaverse space. (Supplementary Note 4)

The advertisement placement possibility determination device according to supplementary note 1, further including a soundness score adjustment unit for adjusting the soundness score,
in which the soundness score adjustment unit adjusts the soundness score based on voting of a user.
   (supplementary Note 5)

The advertisement placement possibility determination device according to supplementary note 1, further including a soundness score adjustment unit for adjusting the soundness score,
in which the soundness score adjustment unit analyzes audio content in the metaverse space and adjusts the soundness score.

### (Supplementary Note 6)

The advertisement placement possibility determination device according to supplementary note 1, in which the total soundness score of the metaverse space is periodically calculated after advertisement placement, and the advertisement is automatically withdrawn in a case where the total soundness score falls below a predetermined value.

### (Supplementary Note 7)

The advertisement placement possibility determination device according to supplementary note 1, further including a soundness score adjustment unit for adjusting the soundness score,
in which the soundness score adjustment unit analyzes a communication history in the metaverse space and adjusts the soundness score.

### (Supplementary Note 8)

An advertisement placement possibility determination method including identifying and analyzing an object arranged in a metaverse space posted by a user, calculating a soundness score of the object by AI,
calculating a total soundness score of the metaverse space based on the soundness score, and
determining whether to display an advertisement in a space based on the total soundness score.

### (Supplementary Note 9)

The advertisement placement possibility determination method according to supplementary note 8, further including adjusting the soundness score based on a relationship among a plurality of the objects arranged within a predetermined distance.

### (Supplementary Note 10)

A program for causing an information processing device to execute identifying and analyzing an object arranged in a metaverse space posted by a user,
calculating a soundness score of the object by AI,
calculating a total soundness score of the metaverse space based on the soundness score, and
determining whether to display an advertisement in a space based on the total soundness score.

Some or all of the elements (e.g., configurations and functions) described in Supplementary Notes 2 to 7 dependent on Supplementary Note 1 {e.g. device} can also be dependent on Supplementary Note 8 {e.g. method} and Supplementary note 10 {e.g. program} by dependency relationships similar to those of Supplementary Notes 2 to 7. Some or all of the elements described in any Supplementary Note may be applied to various types of hardware, software, recording means for recording software, systems, and methods.

What is claimed is:

1. An advertisement placement possibility determination device comprising:
a memory configured to store an instruction; and
a processor configured to execute the instruction to:
identify and analyze an object arranged in a metaverse space posted by a user;
calculate a soundness score of the object by Artificial Intelligence (AI);
calculate a total soundness score of the metaverse space based on the soundness score; and
determine whether to display an advertisement in a space based on the total soundness score.

2. The advertisement placement possibility determination device according to claim 1, wherein the processor is further configured to execute an instruction to adjust the soundness score based on a relationship among a plurality of the objects arranged within a predetermined distance.

3. The advertisement placement possibility determination device according to claim 1, wherein the processor is configured to execute an instruction to adjust the soundness score using a language model specialized for text content in the metaverse space.

4. The advertisement placement possibility determination device according to claim 1, wherein the processor is configured to execute an instruction to adjust the soundness score based on voting of a user.

5. The advertisement placement possibility determination device according to claim 1, wherein the processor is configured to execute an instruction to analyze audio content in the metaverse space and adjust the soundness score.

6. The advertisement placement possibility determination device according to claim 1, wherein the processor is configured to execute an instruction to periodically calculate the total soundness score of the metaverse space after advertisement placement, and automatically withdraw the advertisement in a case where the total soundness score falls below a predetermined value.

7. The advertisement placement possibility determination device according to claim 1, wherein the processor is configured to execute an instruction to analyze a communication history in the metaverse space and adjust the soundness score.

8. An advertisement placement possibility determination method comprising:
identifying and analyzing an object arranged in a metaverse space posted by a user;
calculating a soundness score of the object by AI;
calculating a total soundness score of the metaverse space based on the soundness score; and
determining whether to display an advertisement in a space based on the total soundness score.

9. The advertisement placement possibility determination method according to claim 8, further comprising adjusting the soundness score based on a relationship among a plurality of the objects arranged within a predetermined distance.

10. The advertisement placement possibility determination method according to claim 8, further comprising adjusting the soundness score using a language model specialized for text content in the metaverse space.

11. The advertisement placement possibility determination method according to claim 8, further comprising executing an instruction to adjust the soundness score based on voting of a user.

12. The advertisement placement possibility determination method according to claim 8, further comprising analyzing audio content in the metaverse space and adjusting the soundness score.

13. The advertisement placement possibility determination method according to claim 8, further comprising periodically calculating the total soundness score of the metaverse space after advertisement placement, and automatically withdrawing the advertisement in a case where the total soundness score falls below a predetermined value.

14. The advertisement placement possibility determination method according to claim 8, further comprising analyzing a communication history in the metaverse space and adjusting the soundness score.

15. A non-transitory recording medium recording a program for causing an information processing device to execute:
identifying and analyzing an object arranged in a metaverse space posted by a user;
calculating a soundness score of the object by AI;
calculating a total soundness score of the metaverse space based on the soundness score; and
determining whether to display an advertisement in a space based on the total soundness score.

16. The non-transitory recording medium recording the program according to claim 15, further comprising adjusting the soundness score based on a relationship among a plurality of the objects arranged within a predetermined distance.

17. The non-transitory recording medium recording the program according to claim 15, further comprising adjusting the soundness score using a language model specialized for text content in the metaverse space.

18. The non-transitory recording medium recording the program according to claim 15, further comprising adjusting the soundness score based on voting of a user.

19. The non-transitory recording medium recording the program according to claim 15, further comprising analyzing audio content in the metaverse space and adjusting the soundness score.

20. The non-transitory recording medium recording the program according to claim 15, further comprising periodically calculating the total soundness score of the metaverse space after advertisement placement, and automatically withdrawing the advertisement in a case where the total soundness score falls below a predetermined value.
